(19) United States
(12) Patent Application Publication
(10) Pub. No.: US 2008/0267025 A1
(43) Pub. Date: Oct. 30, 2008

(54) Method of Lens Positioning For Tilt Compensation, Method and Apparatus For Reading And Recording Data Onto An Optical Disc

(75) Inventors: Ruud Vlutters, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,069

(22) PCT Filed: Dec. 5, 2006
(86) PCT No.: PCT/IB06/54601

§ 371 Date: Jun. 12, 2008

(30) Foreign Application Priority Data
Dec. 13, 2005 (EP) 05112059.0

(51) Int. Cl. G11B 5/09

(52) U.S. Cl. 369/47.1

(57) ABSTRACT

A method of controlling the positioning of an objective lens of a lens system for controlling an optical beam used in reading and/or recording information from/onto a track of an optical disc, the method comprising steps of detecting modulated optical signals corresponding to the intensity of a reflected optical beam, the reflected optical beam being modulated by the periodic structures of the track of the optical disc, deriving a radial tilt error signal from the modulated optical signals indicative of a radial tilt, wherein the radial tilt refers to the tilt of the objective lens with respect to the optical disc in a radial direction; using the radial tilt error signal for adjusting the position of the objective lens with respect to the optical disc in a radial direction, the method characterized by using the radial tilt error signal for adjusting the position of the objective lens by means of a feedback loop. The radial tilt error signal may be proportional to a cross correlation signal between a Radial Push Pull (RPP) signal and a Central Aperture (CA) signal or a cross correlation signal between a Radial Push Pull (RPP) and a Diagonal Push Pull (DPP) signal.

### FIELD OF THE INVENTION

The present invention relates generally to a method of controlling the positioning of an objective lens of a lens system for controlling an optical beam used in reading and/or recording information from/onto a track of an optical disc. The application also relates to a method of reading and/or recording data from/onto an optical disc and an apparatus for reading and/or recording data from/onto a track of an optical disc.

### BACKGROUND OF THE INVENTION

Optical disc technology relies on focusing an electromagnetic beam in a small spot onto an information layer under a protective cover layer of an optical disc for reading and or recording information. The density of information that is recorded in the information layer of an optical disc has been increasing continuously. For example, while optical disc of the CD type had a track pitch of 1.6 μm, in case of optical disc of the DVD type the track pitch is only 0.74 μm, corresponding to an increase of 7 times in information density.

Future high-density optical discs, such as the Blu-Ray (BD) optical discs, have even higher densities: the track pitch is 0.320 μm; the minimum bit length is 74 nm. In order to be able to reproduce and/or record information from/onto such media, BD optical disc apparatuses make use of a shorter wavelength of 405 nm and an increased numerical aperture NA=0.85.

However, when discs are tilted with respect to the objective lens, a coma aberration occurs with the focused beam, asymmetrically distorting the beam spot. Such coma aberration is proportional to the substrate thickness and the tilt angle of the disc with respect to the objective lens. The coma aberration is also proportional to the third power of the numerical aperture. Consequently, BD systems are expected to be more sensitive to coma aberrations due to the much higher numerical aperture (NA).

Optical signals are distorted by said aberrations when the objective lens of an optical pick-up unit (OPU) is under tilt with respect to the optical disc. This tilt can be either in the direction of the tracks, known in the art as tangential tilt or in a direction substantially perpendicular to the track direction, known in the art as radial tilt. The undesirable effects of tangential tilt can be compensated by further signal processing because it mainly distorts a channel impulse response. On the other side, the consequence of radial tilt distortions is the presence of cross talk from a signal corresponding to data present in the neighboring tracks. As the data in neighboring tracks is completely independent of the data present in the central track that is being read and/or recorded, this cross talk is equivalent to adding additional noise to the optical signals. Therefore, minimizing radial tilt is important for obtaining a high signal to noise ratio.

In order to reduce said effects of radial tilt, it is known to perform lens tilt adjustment at the time of production of the apparatus. This method is known to compensate the static tilt due to non-parallelism of the tray of the apparatus with respect to the objective lens. US Patent Application No 2003/0099171 proposes the use of an optical signal, for example the central aperture (CA) signal, in performing a lens tilt adjustment each time a disc is inserted into the apparatus. Such method allows compensating the static radial tilt due to the positioning of the optical disc on the tray of the apparatus. Said method is slow as it relies in using a parabolic fit for maximizing a generated signal as function of the tilt angle, the tilt angle being varied in fixed steps.

### SUMMARY OF THE INVENTION

It is an object of the invention to provide a method of controlling the positioning of an objective lens that is fast and reliable. The object of the invention is reached by a method according to claim 1. In case of high density optical discs, such Blu-ray discs (BD), the higher information density is associated to higher bit rates for reading and/or recording data, which in turn require higher data bandwidths in the data readout and processing channels of the apparatus, which in turn make such apparatuses more sensitive to noise. Hence, it is important that all noise sources for the data channel, including radial tilt, are minimized in such systems. Moreover, it is desirable that the method is fast so that it can be performed as often as necessary. In a method according to the invention, a radial tilt error signal indicative of a radial tilt is derived from modulated optical signals corresponding to the intensity of a reflected optical beam, the reflected optical beam being modulated by the periodic structures of the track. The radial tilt error signal is further used for adjusting the position of the objective lens with respect to the optical disc in a radial direction by means of a feedback loop. Hence, the method according to the invention allows compensating the radial tilt in real time.

Said method carries the additional advantage the generation of the radial tilt error signal is based on optical signals that are already present in an optical scanning apparatus, minimizing therefore the costs of implementing the method by modifying known apparatus.

In a further advantageous embodiment, a method according to the invention comprises the radial tilt error signal being proportional to a cross correlation signal between a radial push pull (RPP) signal and either a Central Aperture (CA) signal or a Diagonal Push Pull (DPP) signal. Due to a slight sinusoidal displacement of the track from its central line, the Radial Push Pull (RPP) signal would comprise a periodic component having a characteristic frequency above the bandwidth of the optical scanning apparatus. Deformations of the optical spot, due to coma aberration induced by the radial tilt, will change the correlation between different optical signals, thereby providing a means of detecting radial tilt. It has been discovered that a cross-correlation signal between the Radial Push Pull (RPP) signal and the Diagonal Push Pull (DPP) signal or the cross-correlation signal between the Central Aperture (CA) signal and the Radial Push Pull (RPP) signal offer a high enough sensitivity to detecting the radial tilt, therefore may be used to advantage in generating a radial tilt error signal (RTES). Said correlation signals show a monotonous dependence on the radial tilt, therefore they are usable for implementing a feedback loop for minimizing radial tilt. Moreover, the use of said cross correlation signal carries the advantage that it does not rely on the presence of user data; therefore it is usable on empty optical disc.

In using the cross-correlation signal between a radial push pull (RPP) signal and either a Central Aperture (CA) signal or a Diagonal Push Pull (DPP) signal in generating a radial tilt error signal, it is advantageous to band pass filtering the modulated optical signals. Such band pass filtering, having preferably pass band being in a range from 0.1˜0.5 to 2˜4 times the characteristic (wobble) frequency, allows a higher signal to noise ratio for the radial tilt error signal.

In an embodiment of the method according to the invention, the cross correlation signal is low pass filtered. Low pass filtering, for example with filters having a cut-off frequency that is lower than the characteristic frequency of the periodic component due to the sinusoidal displacement of the track from its central line has the advantage of improving the signal to noise ratio in the radial tilt error signal (RTES).

In a further advantageous embodiment, a method according to the invention is characterized by choosing the Central Aperture (CA) signal for generating the radial tilt error signal. Another important aspect of a good radial tilt estimator is its insensitivity to other system parameters, like tangential tilt (TT), defocus (DEF), de-tracking (DET) and spherical aberration (SA). It was discovered that the cross correlation signal of the Radial Push Pull (RPP) signal with Diagonal Push Pull (DPP) signal is sensitive for the other system parameters such as TT, DEF or SA, hence being a poor radial tilt estimator. On the other side, the cross-correlation of Central Aperture (CA) with Radial Push Pull (RPP) was found to be insensitive to all these system parameters, consequently being an advantageous option for generating the radial tilt error signal.

In an embodiment of the method, the radial tilt error signal is used for adjusting the position of the objective lens by means of a feedback loop comprising a PID controller. In an embodiment of the invention, the said feedback loop is used simultaneously with a feedback loop for following the track of the optical disc. Such tracking loop is required to be closed when following the track of the optical disc in order to read and/or record data from/onto the optical disc. Consequently, by said two loops being used simultaneously it is possible to compensate dynamic radial tilt during data readout and/or recording therefore insuring an optimum signal to noise ratio in the data channel.

The invention also relates to a method of reading and/or recording data from/onto an optical disc, the method comprising controlling the positioning of an objective lens of a lens system for controlling an electromagnetic beam used in reading and/or recording information from an optical disc according to the invention.

The invention also relates to an apparatus for reading and/or recording data from/onto a track of an optical disc, the apparatus comprising, a lens system for controlling an electromagnetic beam used in reading or recording information from the track of an optical disc, actuation means for controlling the positioning of an objective lens of the lens system relative to the optical disc, signal generation means for generating a radial tilt error signal indicative a radial tilt, wherein the radial tilt refers to the tilt of the objective lens with respect to the optical disc in a radial direction and control means for controlling the actuation means based on the radial tilt error signal generated by the signal generation means; the apparatus being characterized in that, the control means and the actuation means are enabled to adjust the position of the objective lens continuously while reading and/or recording information from/onto a track of an optical disc.

These and other aspects of the invention are apparent from and will be explained with reference to the embodiments described hereinafter.

### BRIEF DESCRIPTION OF THE DRAWINGS

The features and advantages of the invention will be appreciated upon reference to the following drawings, in which:

FIG. 1 illustrates schematically a block diagram of an optical disc drive wherein the invention may be practiced;

FIGS. 2a and 2b illustrate schematically a block diagram of an optical pick up unit wherein the invention may be practiced and a detection system;

FIG. 3 illustrates for several cross-correlations signals the dependence on the amount of radial tilt;

FIG. 4 illustrates for RPPxDPP and RPPxCA cross-correlation signals the dependence on the amount of defocus;

FIGS. 5a and 5b illustrate schematically a block diagram of a unit for generating an radial tilt error signal (RTES) according to two embodiments of the invention;

FIG. 6 illustrates a unit for using a feedback loop radial based on the radial tilt error signal (RTES) for controlling the position of an objective lens in the radial direction according to the invention.

### DETAILED DESCRIPTION OF THE PREFERRED EMBODIMENTS

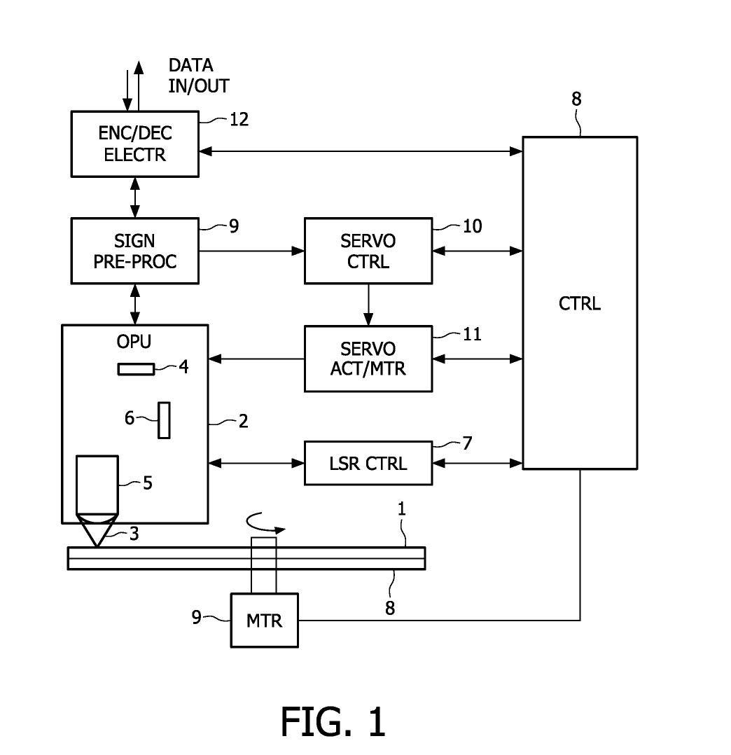

A block diagram of a optical disc drive wherein the invention may be practiced is shown in FIG. 1. An optical disc (1), placed on a turntable (8), is rotated by a turntable motor (9). The rotation velocity of the turntable motor (9) is controlled by a controller (8). Encoded information is either read from or recorded thereonto the optical disc (1) by means of an Optical Pick-up Unit (OPU) (2). The Optical Pick-up Unit (2) generates and focuses an electromagnetic beam (3) onto the optical disc and it receives a reflected electromagnetic beam which is modulated by a periodical structure on the optical disc (1). The Optical Pick-up Unit (OPU) (2) comprises, among others components, a laser diode (4) for generating the electromagnetic beam (3), a lens system (5) for focusing the beam on the disc, and a detection system (6) comprising several photodiodes for transforming the received reflected electromagnetic beam into photocurrents. The output power of the laser is controlled by a laser controller (7), which on its turn is controlled by a general controller (8), usually also comprising a digital signal processor (DSP).

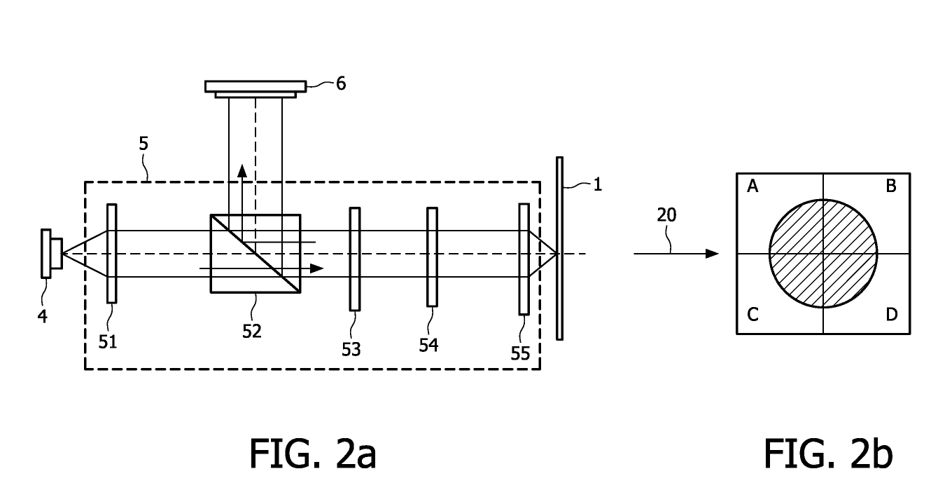

Further details of the lens system (5) and of detection system (6) will be discussed with reference to FIGS. 2a and 2b. Throughout the figures, when the same functional element appears in several figures, the same reference numeral is used to simplify understanding. The embodiment of the lens system (5) described herein after corresponds to that may be used for a Blu-ray (BD) optical disc drive. Other alternative embodiments, corresponding for example to CD and DVD optical disc drives, are known in the art.

The divergent beam generated by the laser diode (4) is collimated by a collimator lens (51) and passes through a polarizing beam splitter (52). Further, the beam is passed through an optical element for removing spherical aberrations (53) a quarter wavelength (λ/4) element (54) for changing the polarization direction and an objective lens (55) for focusing the beam onto a spot in an information layer of the optical disc (1). The reflected beam passes through the objective lens (55), the quarter wavelength (λ/4) element (54) and the optical element (53) for removing spherical aberrations (53). The reflected beam is reflected by the polarizing beam splitter (52) towards the detector system (6).

The detector system (6) is a four-quadrant detector, the being denoted with A, B, C, and D. The relative positioning of the four quadrants with respect to a track scanning direction (20) of the optical disc (1) is shown in FIG. 2b. Each quadrant comprises a photodetector for transforming the intensity of the received beam into a quadrant electrical signal (A, B, C, D).

Returning to the optical disc drive as disclosed in FIG. 1, the quadrant electric signals (A, B, C, D) generated by the detector system (6) are pre-processed by a signal preprocessing unit, for example by means of pre-amplifying and, optionally, by filtering. Moreover, by combining signals generated by each quadrant detector, the following signals may be constructed:

a central aperture signal (CA): CA=A+B+C+D);

a radial push pull signal (RPP): RPP=(A+D)−(B+C);

a tracking push pull signal (TPP): TPP=(A+B)−(D+C);

a diagonal push pull signal (DPP): DPP=(A+C)−(B+D).

The central aperture signal (CA) carries high frequency information due to signal modulation by the periodic structures in the track of the optical disc and is normally used for data detection. The radial push pull signal (RPP) is sensitive to radial displacement of the spot relative to the track and is used for example in generating a radial error tracking signal.

The pre-processed central aperture signal (CA) carrying the high frequency information is fed to an encoder/decoder unit (12), which decodes the incoming signal to obtain the information stored on the disc. The decoder unit (12) may also perform error detection and correction. The decoded information may also be fed to the controller (8), which may further process the decoded information.

The pre-processed signals generated by the signal pre-processing unit (9) are used in generating control error signals for aligning and focusing the lens system with respect to the track of the optical disc.

Fine displacement of the lens system (5) along the axial and the radial direction and coarse displacement of the whole Optical Pick-up Unit (OPU) (2) with respect to the optical disc (1) is controlled by a servo unit (10). The servo unit (10) receives the pre-processed servo signals from the pre-processing unit (9) and is controlled by the controller (8).

For each control signal, a separate control feedback loop is present. If the control signal is a servo signal, the control loop is also known as a servo loop. Separate from the servo system, mechanisms for tilt adjusting are already available in state of art optical pick-up units (OPU) for e.g. lens-to-disc alignment purposes. Such lens tilting mechanisms may be either one that allows tilting the whole optical pick-up unit (OPU), i.e. the entire light path as illustrated in FIG. 2 or, alternatively, a mechanism known in the art as a 3D or 4D actuators. Such 3D or 4D actuators not only performs focusing and tracking movement (translation) of the objective lens 55, but it also allows tilting the objective lens 55 along one (3D) or two perpendicular axes (4D).

Optical signals are distorted by coma aberrations when the objective lens of an optical pick-up unit (OPU) is under tilt with respect to the optical disc. This tilt can be either in the direction of the tracks, known in the art as tangential tilt or in a direction substantially perpendicular to the track direction, known in the art as radial tilt. The undesirable effects of tangential tilt can be compensated by further signal processing because it mainly distorts a channel impulse response.

With respect to radial tilting, it is known in the art to use a radial tilt estimation method, for example as described in PCT application no WO 2004/105003. Said method comprises steps of opening the radial tracking loop, used for following a track in the radial direction, and measuring the push-pull amplitude. Next, the direction of the objective lens with respect to a radial direction is adjusted in predetermined steps such that the push-pull amplitude is maximized by using a parabolic fit method. As the radial tracking loop is open when performing the tilt adjusting method as described in WO 2004/105003, said method is slow and introduces delays, as it requires that a track is sought again after the method is performed.

Higher information densities on an optical disc of the BD type correspond to higher bit rates for reading and/or recording data, which in turn require higher data bandwidths in the data readout and processing channels of the optical disc drive. In turn, the higher bandwidths make such apparatuses more sensitive to noise. Hence, it is essential that all noise sources for the data channel, including radial tilt, be minimized in such systems, for example by performing a radial tilt compensation regularly.

A solution according to the invention for providing a fast and reliable method for radial tilt compensation is to generate in real time a radial tilt error signal (RTES) and using the RTES signal in generating a feedback loop such that the radial tilt can be compensated in real time while scanning an optical disc. However, such solution can only be implemented if a good estimator for radial tilt is identified. Specifically, it should be possible to generate the estimator fast enough such that it can be used in real time while scanning the optical disc. It was identified that it is possible to generate a radial tilt error signal (RTES) start from the electrical signals generated by the detector system (6). Such electrical signals provide the required bandwidth. Moreover, as said electrical signals are already available in optical disc drive, the cost of implementing the invention is reduced.

When analyzing the electrical signals generated by each quadrant of the detector system (6) and the constructed CA, RPP, TPP and DPP signals, while scanning an empty Blu-Ray optical disc, a sine-wave like distortion signal is present, due to a slight sinusoidal displacement of the track from its middle line. This displacement may be due for example due to the wobble of the track and/or groove, said sine-wave like distortion signal is known in the art as the wobble signal. As the push pull signals are more sensitive to radial displacements of spot with respect to the track, said wobble signal is strongest in the either the radial push pull signal (RPP) or the diagonal push pull signal (DPP). Said wobble signal comprises a characteristic frequency in the range above 1 Mhz. The presence of such wobble signal does not influence the tracking performance because its characteristic frequency is beyond the servo bandwidth. Distortions of the optical spot, for example due to radial tilt, leads to this sine-wave like distortion (wobble) signal being present in other constructed signals than radial push pull signal (RPP) or the diagonal push pull signal (DPP). Consequently, the cross-correlation signal between the either the radial push pull signal (RPP) or the diagonal push pull signal (DPP) and another constructed signal (CA, RPP, TPP or DPP) may be used for estimating the amount of radial tilt

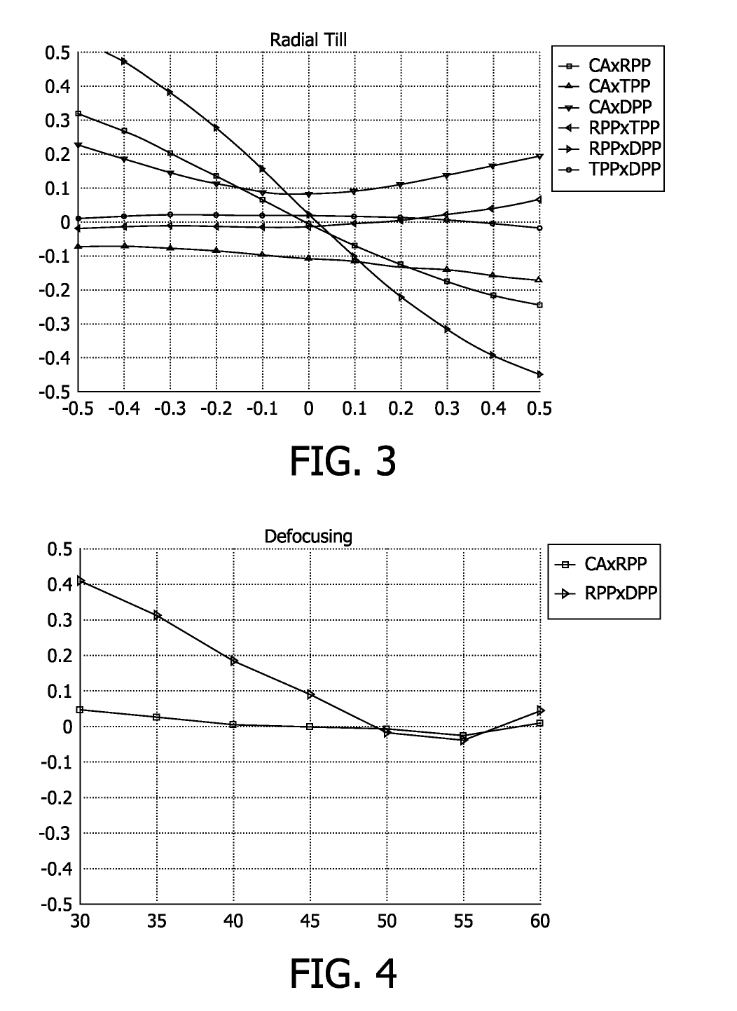

FIG. 3 illustrates for several cross-correlations signals the dependence on the amount of radial tilt;

If a signal is to be used for estimating the amount of radial tilt, then it should satisfy the criteria that a strong and preferably monotonous dependence between the value of the said signal and the radial tilt is present. It was discovered and it can be see from the measurements shown in FIG. 3, that the cross correlation signal between the radial push pull signal (RPP) and the central aperture (CA) signal and the cross correlation signal between the radial push pull signal (RPP) and the diagonal push pull signal (DPP) satisfy said criteria, therefore can be used for estimating the radial tilt. Other cross correlation signal do not show such a strong dependence on the radial tilt.

In addition to said criteria, another important aspect of a good estimator for a radial tilt is selectivity to radial tilt. Therefore, a second criterion is the insensitivity to other system parameters, for example tangential tilt (TT), defocus (DEF), de-tracking (DET) and spherical aberration (SA).

FIG. 4 illustrates for RPPxDPP and RPPxCA cross-correlation signals the dependence on the amount of defocus. From the dependence shown in FIG. 4, it can be seen that the correlation of the RPP with DPP signal is too sensitive to defocus (DEF), hence being a less attractive radial tilt estimator. On the other side, the cross correlation signal between the radial push pull signal (RPP) and the central aperture signal (CA) appears to be insensitive to the other system parameters, therefore it can be advantageously used for generating a radial tilt error signal (RTES).

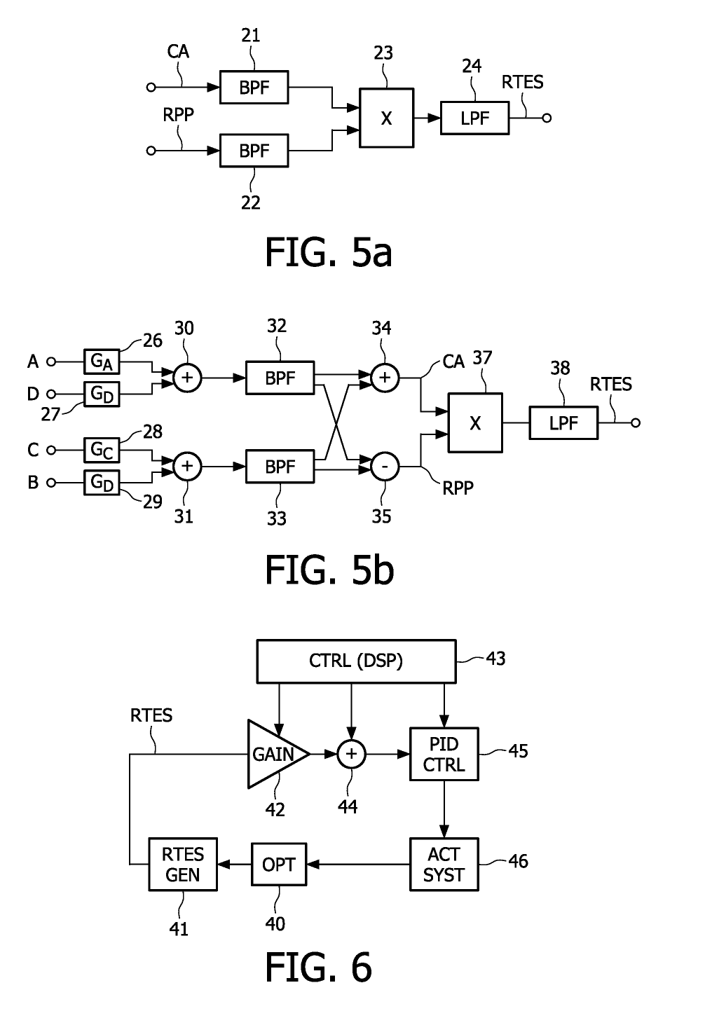

FIG. 5a illustrates schematically a block diagram of a RTES generator unit for generating a radial tilt error signal (RTES) according to an embodiment of the invention.

The central aperture signal (CA) and the radial push pull signal (RPP) are received as inputs, and optionally are each passed through a band pass filter (21,22), each band pass filter having a pass band from 0.1˜0.5 to 2˜4 times the characteristic frequency of sine-wave like distortion signal. The central aperture signal (CA) and the radial push pull signal (RPP) are then correlated by means of a multiplier (23). Finally, the signal generated by the multiplier is low-pass filtered. The characteristic cut-off frequency of the low pass filter (24) is chosen in the kHz range, such that it is much lower than the characteristic frequency of sine-wave like distortion signal. The output of the low pass filter (24) is the radial tilt error signal (RTES). Optionally, the low pass filter may be replaced by an integrator. In an alternative embodiment of the invention, the processing of the signals, such as cross-correlating and filtering, is performed by a digital signal processor.

In an alternative embodiment of the invention as shown in FIG. 5b, the four-quadrant electric signals (A, B, C, D) are band pass filtered before the central aperture signal (CA) and the radial push pull signal (RPP) are generated. The four quadrant signals are pre-amplified in the pre-amplifiers (26,27,28,29) and, optionally, normalized, for example by adjusting the gain of each pre-amplifier (26,27,28,29). Pre-amplified quadrants electric signals A and D are sent to an adder (30) to generate a left detector signal, while Pre-amplified quadrants electric signals B and C are sent to a second adder (31) to generate a right detector signal. Next the left and right detector signals are band pass filtered, the pass band being chosen from 0.1˜0.5 to 2˜4 times characteristic frequency of sine-wave like distortion signal. By adding (34) and subtracting (35) of the left and right detector signals, the central aperture signal (CA) and the radial push pull signal (RPP), respectively, are obtained. Finally, the central aperture signal (CA) and the radial push pull signal (RPP) are cross-correlated by a multiplier (37). The resulting signal is low-pass filtered (38) to generate the radial tilt error signal.

FIG. 6 illustrates a feedback unit according to the invention for using a feedback loop based on the radial tilt error signal (RTES) for controlling the position of an objective lens in the radial direction.

Modulated optical signals are generated by optical signal generation means (40), comprising the laser diode (4) and lens system (5) as described with reference to FIG. 2. Based on the modulated optical signals, a radial tilt error signal (RTES) is generated by the RTES generator unit (41) according to the invention and described herein before with respect to FIG. 5.

The radial tilt error signal (RTES) is amplified by the variable gain amplifier (42). The gain of the variable gain amplifier (41) is controlled by a controller (43), usually a Digital Signal Processor (DSP). The function of the variable gain amplifier (42) is to control the total gain of the feedback loop. Any offset present in the amplified radial tilt error signal (RTES) is removed by an offset comparator (44). The offset comparator (44) is also controlled by the Digital Signal Processor (DSP). In an alternative embodiment, the offset comparator (44) and the amplifier (42) may be integrated into the same amplification unit. The signal generated by the offset comparator (44) is then sent to the Proportional Integral Derivative (PID) controller (45). The role of the PID controller (45) is to provide feedback so that the value of the radial tilt error signal (RTES) is maintained within a certain range around zero. In an alternative embodiment, the functions of the PID controller (45) may be partially integrated in the Digital Signal Processor (DSP) (43). The values of the proportional, integral and derivative components of the feedback signal generated by the PID controller (45) are controlled by Digital Signal Processor (DSP) (45). The feedback signal generated by the PID controller (45) is fed to the corresponding actuator (46) in the optical pick up unit (OPU) (2) responsible for tilting the objective lens (55) in the radial direction. Changes in the actuator position (46) produce corresponding changes in the intensity of the modulated optical signals detected by the detection system (40) and consequently the radial tilt error signal (RTES) generated by the RTES generator unit (41), therefore closing the feedback loop.

The above feedback loop associated with the RTES signal may be maintained while a closed radial error tracking loop is maintained. Consequently, there is no need to perform a track seek after a radial tilt compensation was performed.

The above-described method of compensating could be advantageously used for obtaining an improved method of recording data onto an optical disc. In such a method of recording data onto an optical disc according to the invention, prior to recording, first the radial tilt is compensated before the recording process is started. Optionally, the radial tilt may be compensated periodically by interrupting the record process, jumping to the next available empty track in the radial direction and performing the tilt compensation method as described in the invention. This allows to compensate dynamic tilt due to disc warping/bending.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable firmware. Firmware may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measured cannot be used to advantage.

1. A method of controlling the positioning of an objective lens of a lens system for controlling an optical beam used in reading and/or recording information from/onto a track of an optical disc,
the method comprising steps of:
detecting modulated optical signals corresponding to the intensity of a reflected optical beam, the reflected optical beam being modulated by the periodic structures of the track of the optical disc;
deriving a radial tilt error signal from the modulated optical signals indicative of a radial tilt, wherein the radial tilt refers to the tilt of the objective lens with respect to the optical disc in a radial direction;
using the radial tilt error signal for adjusting the position of the objective lens with respect to the optical disc in a radial direction;
the method characterized by
using the radial tilt error signal for adjusting the position of the objective lens by means of a feedback loop.

2. A method according to claim 1, characterized by the radial tilt error signal being proportional to a cross correlation signal between a Radial Push Pull (RPP) signal and a Central Aperture (CA) signal or a cross correlation signal between a Radial Push Pull (RPP) and a Diagonal Push Pull (DPP) signal.

3. A method according to claim 2, characterized by band pass filtering the modulated optical signals.

4. A method according to claim 3, characterized by the pass band being in a range from 0.1˜0.5 to 2˜4 times the wobble frequency.

5. A method according to claim 2, characterized by low pass filtering the cross correlation signal.

6. A method according to claim 2, characterized by choosing the radial tilt error signal being proportional to a cross correlation signal between a Radial Push Pull (RPP) signal and a Central Aperture (CA) signal.

7. A method according to claim 2, characterized by the feedback loop comprising a PID controller.

8. A method according to claim 7, characterized by simultaneously using said feedback loop with using a feedback loop for following the track of the optical disc.

9. A method of recording data onto an optical disc, the method comprising controlling the positioning of an objective lens of a lens system for controlling an electromagnetic beam used in reading and/or recording information from an optical disc according to claim 1.

10. An apparatus for reading and/or recording data from/onto a track of an optical disc, the apparatus comprising:
a lens system for controlling an electromagnetic beam used in reading or recording information from the track of an optical disc;
actuation means for controlling the positioning of an objective lens of the lens system relative to the optical disc;
detection means for detecting modulated optical signals corresponding to the intensity of a reflected optical beam, the reflected optical beam being modulated by the periodic structures of the track of the optical disc;
signal generation means for generating a radial tilt error signal indicative a radial tilt, wherein the radial tilt refers to the tilt of the objective lens with respect to the optical disc in a radial direction;
control means for controlling the actuation means based on the radial tilt error signal generated by the signal generation means;
characterized in that, the control means and the actuation means are adapted in order to minimize radial tilt to adjust the position of the objective lens by means of a feedback loop.

11. An apparatus according to claim 10, characterized in that:
the detection means are adapted to generating a radial push pull (RPP) signal and either a Central Aperture (CA) signal or a Diagonal Push Pull (DPP) signal; and
the radial tilt error signal is proportional to a cross correlation signal between a radial push pull (RPP) signal and either a Central Aperture (CA) signal or a Diagonal Push Pull (DPP) signal.

12. An apparatus according to claim 10, characterized in that it further comprises a band pass filter for filtering the modulated optical signals.

13. An apparatus according to claim 10, characterized in that the pass band is of the band pass filter in a range from 0.1˜0.5 to 2˜4 times the wobble frequency.

14. An apparatus according to claim 11, characterized in that the signal generation means are further adapted to low pass filter the cross correlation signal.

15. An apparatus according to claim 11, characterized in that the Central Aperture (CA) signal is chosen for generating the radial tilt error signal.

16. An apparatus according to claim 10, characterized in that the control means comprising a PID controller for generating a feedback loop based on the radial tilt error signal for adjusting the position of the objective lens.

17. An apparatus according to claim 16, characterized by the apparatus further comprising means for generating a tracking servo loop for enabling the lens system to follow the track of the optical disc,
the apparatus being enable to simultaneously use the said feedback loop and the tracking servo loop.
